(19) United States
(12) Patent Application Publication
(10) Pub. No.: US 2021/0379423 A1
(43) Pub. Date: Dec. 9, 2021

(54) SYSTEMS AND METHODS FOR A RAPID MANUFACTURABLE FACE MASK ASSEMBLY

(71) Applicants: Preston Howell, Tempe, AZ (US); Tyler Smith, Tempe, AZ (US)

(72) Inventors: Preston Howell, Tempe, AZ (US); Tyler Smith, Tempe, AZ (US)

(73) Assignee: Arizona Board of Regents on Behalf of Arizona State University, Tempe, AZ (US)

(21) Appl. No.: 17/341,906

(22) Filed: Jun. 8, 2021

Related U.S. Application Data
(60) Provisional application No. 63/036,209, filed on Jun. 8, 2020.

(51) Int. Cl. A62B 23/00; A62B 18/02; A41D 13/11

(52) U.S. Cl. CPC A62B 23/00; A62B 18/025; B33Y 80/00; A41D 13/1161; A41D 13/1146

(57) ABSTRACT

Various embodiments of a system and associated methods for a rapidly manufacturable face mask assembly are disclosed herein. The face mask assembly can be fabricated using methods and materials that are easily accessible and more quickly produced than traditional manufacturing methods. The main mask body is intended to be efficiently 3D printed, with the addition of a removable face seal made of silicone or other soft and flexible polymers. The mask body includes anchor points for various strap options, as well as a custom filter retainer that can be customized to accommodate the use of numerous different filter materials, while the face seal restricts airflow to intake only through the attached filter.

### CROSS-REFERENCE TO RELATED APPLICATIONS

This is a non-provisional application that claims benefit to U.S. Provisional Patent Application Ser. No. 63/036,209 filed 8 Jun. 2020, which is herein incorporated by reference in its entirety.

### FIELD

The present disclosure generally relates to personal protective equipment (PPE), and in particular to systems and methods for a rapidly manufactured, sterilizable face mask which seals around the face and universally accommodates multiple filter material styles are disclosed herein.

### BACKGROUND

In the midst of the COVID-19 pandemic, personal protective equipment and other highly needed items amongst medical personnel became sparse and difficult to obtain. In the early weeks of the pandemic, the supply of personal protective equipment (PPE) including protective mask supply quickly diminished, thereby leading medical and first response workers to wear surgical masks, N95 masks and other similar PPE facial coverings for much longer periods of time than their intended use. Issues with prolonged use of these one-time use disposable PPE products have also surfaced, including skin abrasions and bruising of the face and ears, rapid contamination, and difficulty of sterilization. In addition, many of these PPE masks were less effective given that many do not create a sufficient seal around the user's face, thereby allowing unfiltered air to be drawn in and potentially exposing the user and people in contact with the user to contaminants and viruses. With the supply shortage of these vital healthcare products being the initial problem, the first challenge will be to create a face mask that can be rapidly manufactured with equipment, methods, and materials that are relatively abundant and available to meet ongoing demand.

It is with these observations in mind, among others, that various aspects of the present disclosure were conceived and developed.

### BRIEF DESCRIPTION OF THE DRAWINGS

FIGS. 1A-1D are respective perspective, front, bottom, and side views of a face mask assembly;

FIG. 2 is an exploded view of the face mask assembly of FIG. 1 including a filter assembly;

FIG. 3 is an exploded view of the face mask assembly of FIG. 1 showing a mask body, a face seal, and a strap adjuster;

FIGS. 4A-4D are respective perspective, front, bottom, and side views of the mask body of the face mask assembly of FIG. 1;

FIGS. 4E and 4F show an alternate embodiment and a blank template for fitting alternate filter types of the mask body of FIG. 4;

FIGS. 5A-5D are respective perspective, front, bottom, and side views of the face seal of the face mask assembly of FIG. 1;

FIG. 6 is an exploded view of the filter assembly of FIG. 1;

FIGS. 7A-7C are perspective, side and cross-sectional views of the filter assembly of FIG. 1;

FIGS. 8A and 8B are sequential views showing assembly of the filter assembly of FIG. 1;

FIG. 9 is an exploded view of a mold for manufacture of the face seal of the face mask assembly of FIG. 1;

FIGS. 10A and 10B are respective bottom and top sections of the mold of FIG. 9; and

FIGS. 11A-11F are a series of photographs showing an alternate embodiment of the face mask assembly having a filter assembly for use with a cartridge filter and the mask body of FIG. 3.

Corresponding reference characters indicate corresponding elements among the view of the drawings. The headings used in the figures do not limit the scope of the claims.

### DETAILED DESCRIPTION

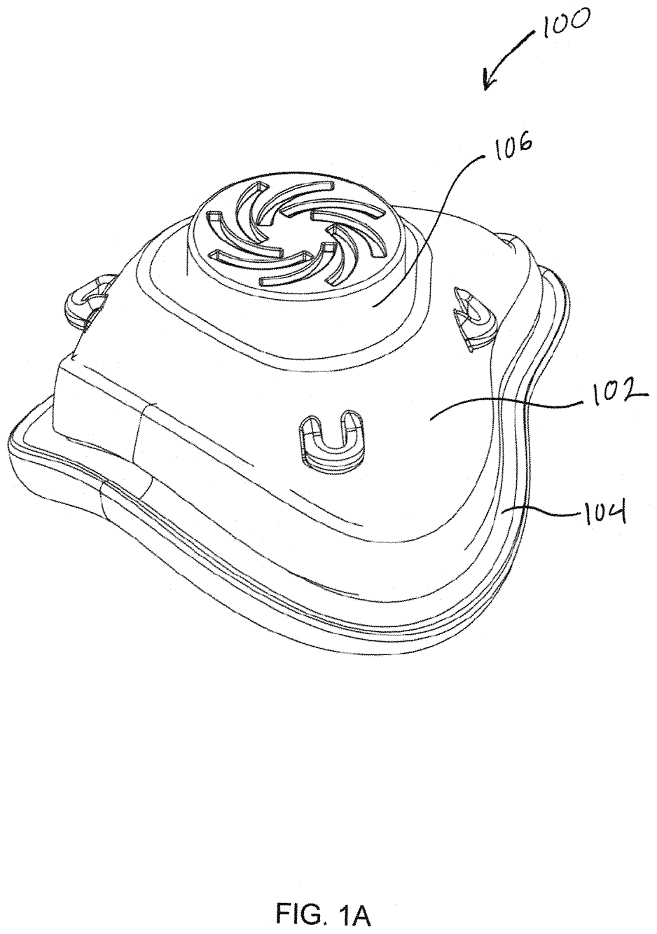

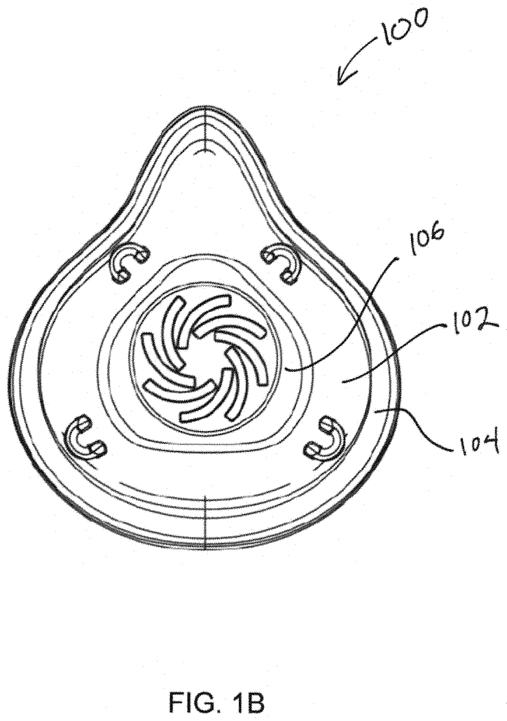

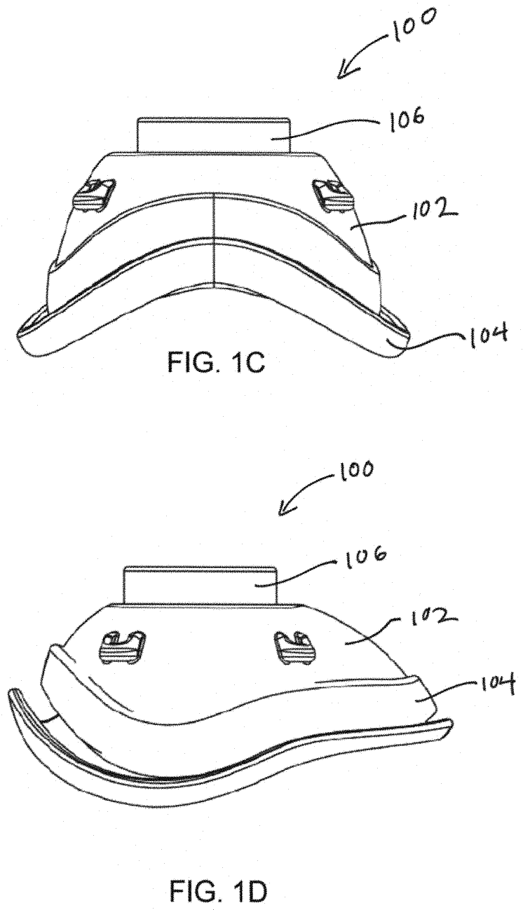

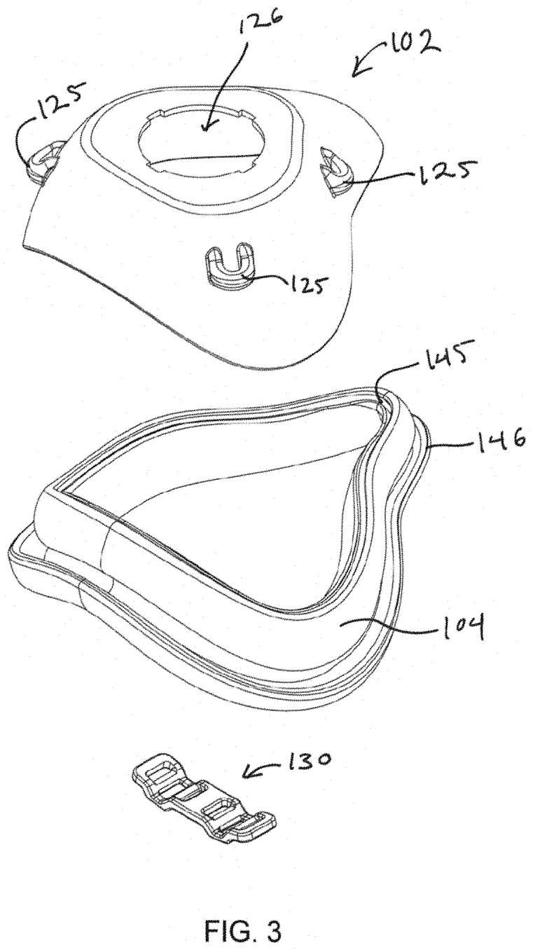

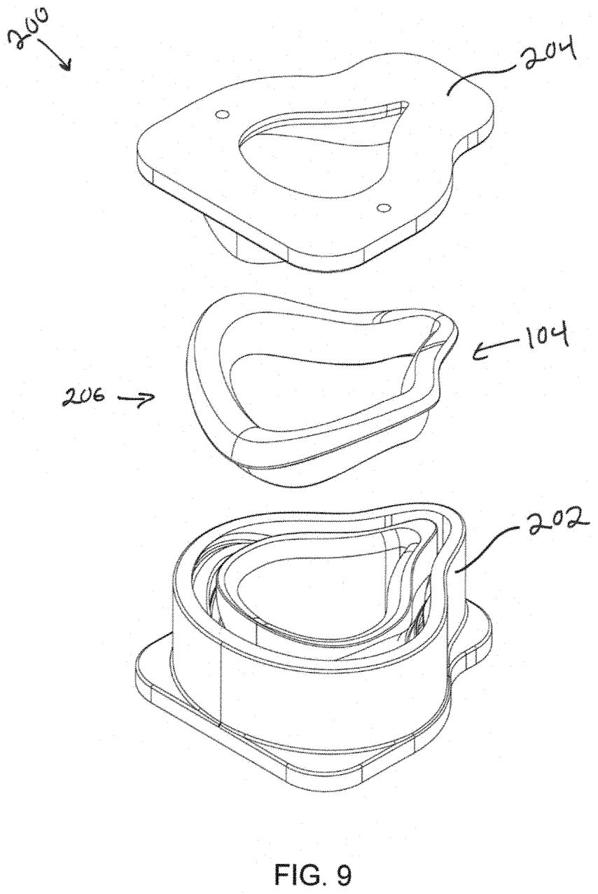

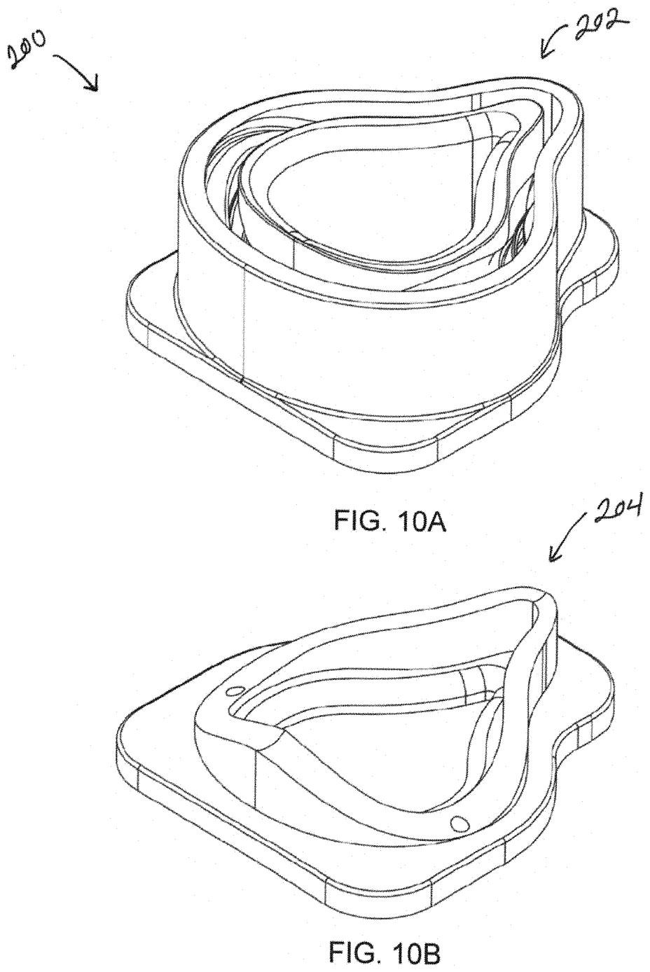

Various embodiments of a system and associated methods for a rapidly manufacturable face mask assembly, herein referred to as the “mask assembly” are disclosed herein. In some embodiments, the mask assembly includes a mask body which is intended to enable accessibility to multiple manufacturing processes using additive manufacturing or large scale injection molding. The mask assembly further includes a face seal manufacturable by large scale injection molding and a filter assembly including a filter retainer intended to secure any filter sheet material. The mask assembly comports to the user's face, creating a seal around the nose and mouth areas, thus allowing air to only enter the mask assembly through the filter. Referring to the drawings, embodiments of a rapidly manufacturable face mask assembly are illustrated and generally indicated as 100 in FIGS. 1-11F.

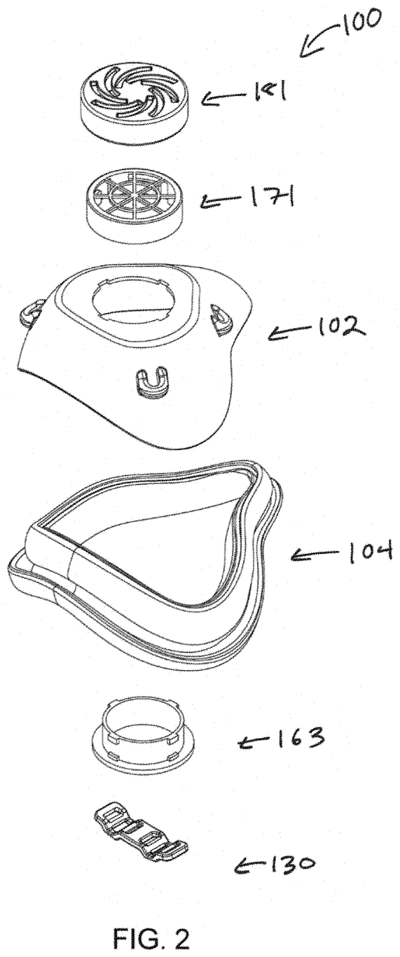

Referring to FIGS. 1 and 2, the mask assembly 100 is shown having a mask body 102 engageable with a separate face seal 104 and a filter assembly 106. The face mask assembly 100 can be worn on the face to cover the mouth and nose of the wearer and remove particulates and contaminants from air drawn through the filter assembly 106. The face seal 104 allows the mask assembly 100 to comfortably create a seal around the nose and mouth to ensure all air passing through the mask assembly 100 enters and exits through the filter assembly 106. The filter assembly 106 can accommodate the use of numerous different filter materials for filtering out viruses, bacterized and other contaminants and is easily replaceable. The mask body 102 and the filter assembly 106 can be fabricated through additive manufacturing (3D printing) without the need for support material, thereby reducing print time and eliminating excess waste. The face seal 106, the mask body 102, and face seal 106 can be manufactured through injection molding. The mask body 102, face seal 104 and filter assembly 106 are designed to be quickly be removed, sterilized and/or replaced.

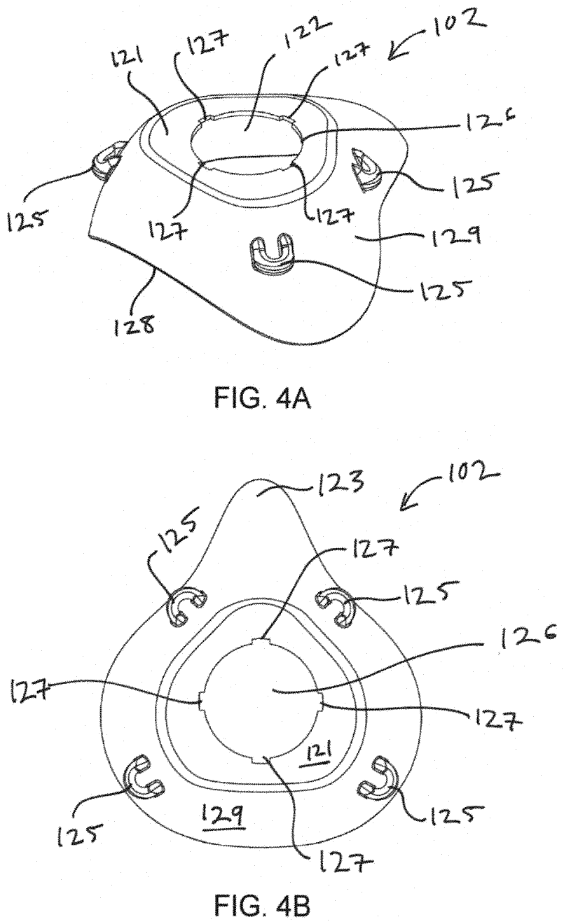

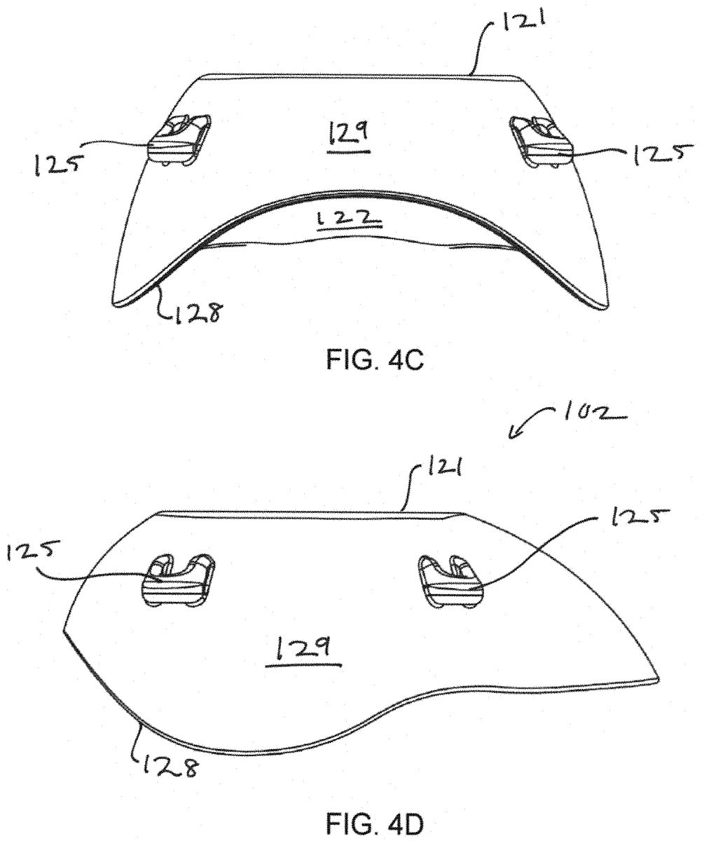

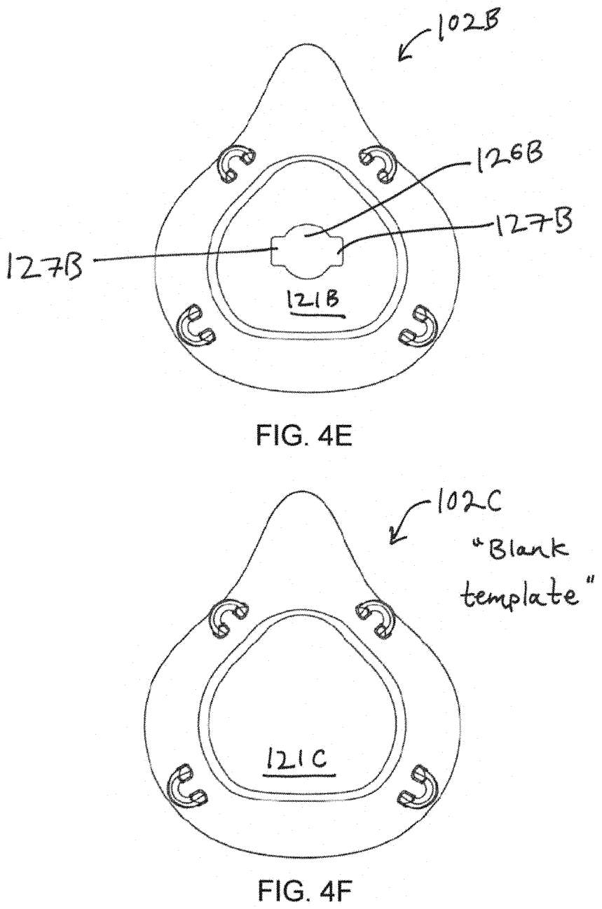

The mask body 102 is shown specifically in FIGS. 4A-4F. As illustrated in FIG. 4B, the mask body 102 can have a generally teardrop-shaped configuration and define a convex outer surface 129, a concave inner surface 122, and a peripheral edge 128. The shape of the mask body 102 is intended to fit comfortably on a human face, including a protrusion 123 formed at the top of the mask body 102 to comfortably fit with the wearer's nose. The convex outer surface 129 defines a flat front 121 and a filter engagement aperture 126. In some embodiments, the filter engagement aperture 126 can define a generally circular shape as well as any other appropriate shape, and a plurality of notches 127 defined circumferentially around the filter engagement aperture 126 for engagement with the filter assembly 106 (FIG. 2), as will be discussed in detail below. The mask body 102 further includes a plurality of anchor points 125 located along the convex outer surface 129 for engagement with each respective strap (not shown) of a plurality of straps (not shown). In one embodiment, each strap can be fastened around the face and behind the head with a strap retainer 130, although in other embodiments that straps may be configured to be fastened around the user's ears. During assembly, the face seal 104 is engaged with the peripheral edge 128 of the mask body 102. Referring specifically to FIG. 4E, an alternate embodiment of the mask body 102B shows an alternate filter engagement aperture 126B defined on a flat front 121B for engaging an alternate filter shape. The filter engagement aperture 126B includes tabs 127B. Referring to FIG. 4F, the filter engagement aperture 126 can be of any appropriate size and shape. A “blank template” is shown on a mask body 102C where any filter engagement aperture 126 can be modeled using CAD on the flat front 121C.

As discussed, the mask body 102 can be effectively fabricated using additive manufacturing methods. In particular, the mask body 102 can be formed by 3D printing without the need for support material. This significantly reduces print time and eliminates material waste. Alternatively, the mask body 102 can also be formed by injection molding with two-part mold tooling. Depending on the circumstance, such as material specification/availability, quantity, and time frame, the mask body 102 can be manufactured using either additive manufacturing or injection molding. In one aspect, the mask body 102 can be removed, replaced, and/or sterilized separately from the face seal 104 and filter assembly 106.

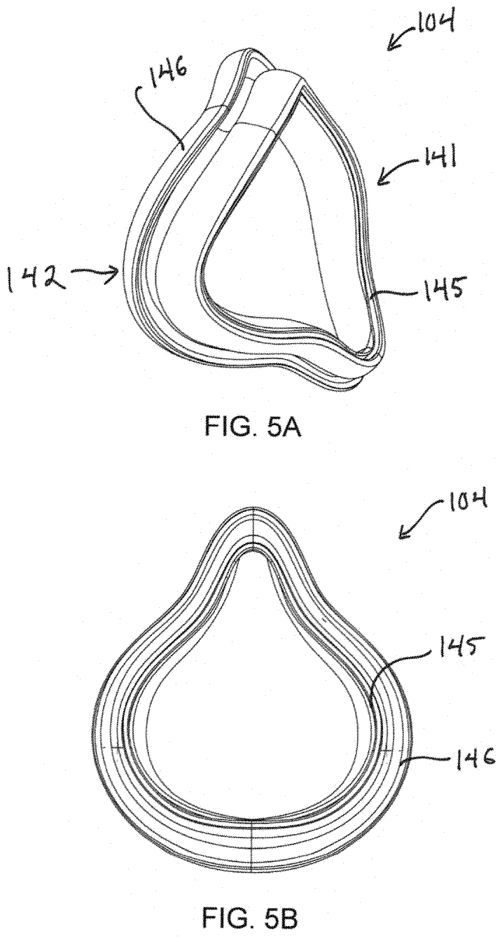

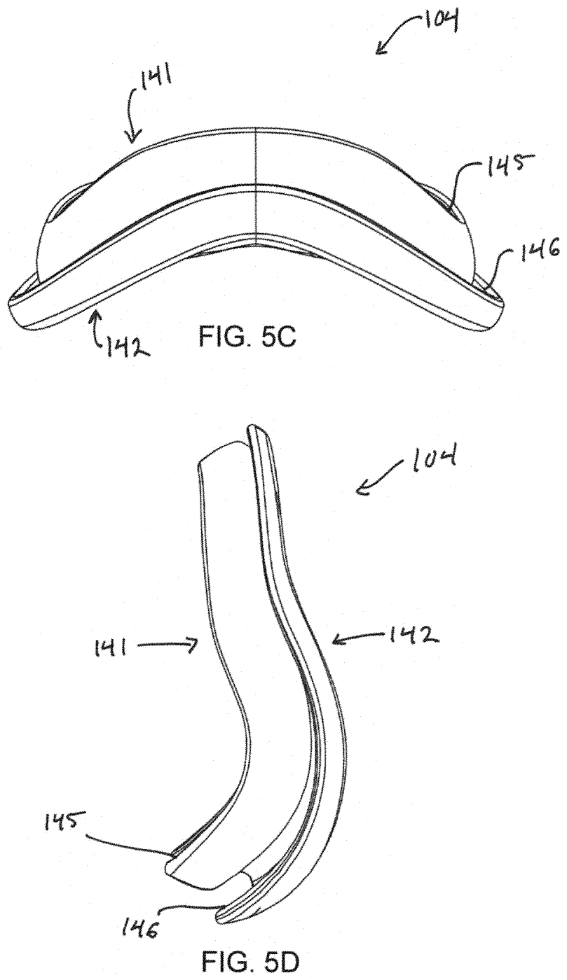

Referring to FIGS. 5A-5D, the face seal 104 is shown having a front section 141 and a rear section 142. The shape of the face seal 104 follows the outline formed by the peripheral edge 128 of the mask body 102. The rear section 142 contacts and forms a seal with the wearer's face. The front section 141 includes an engagement recess 145 for insertion of the peripheral edge 128 of the mask body 102. Further, the face seal 104 includes an outer lip 146 to provide cushioning and ensure flexibility of the face seal 104 in adhering to a wearer's face.

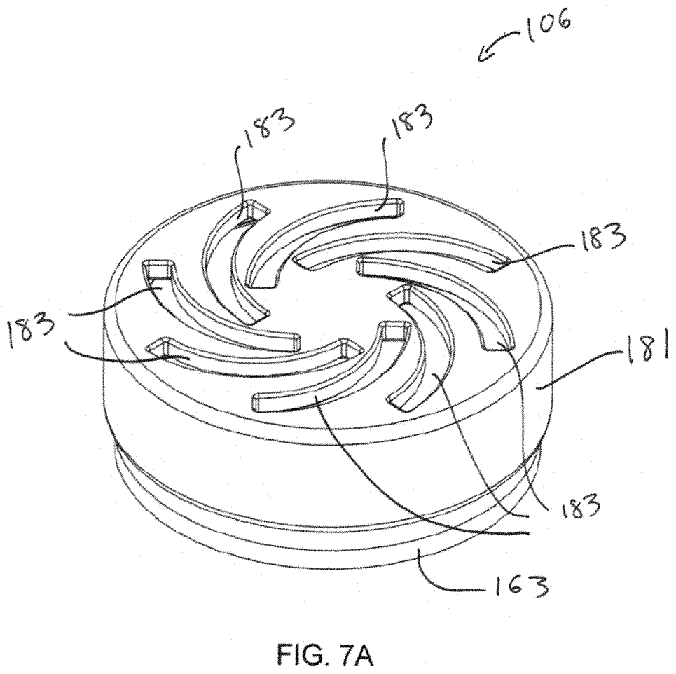

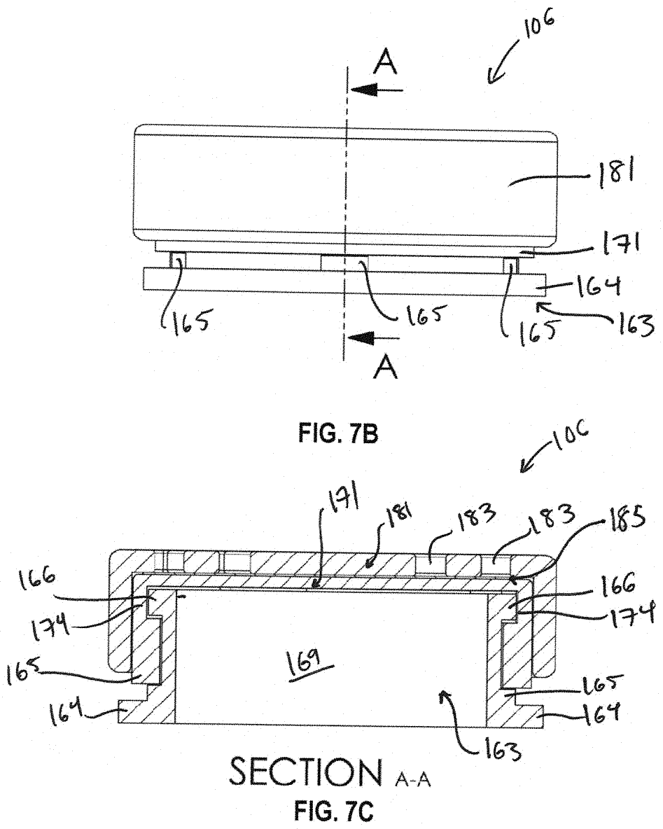

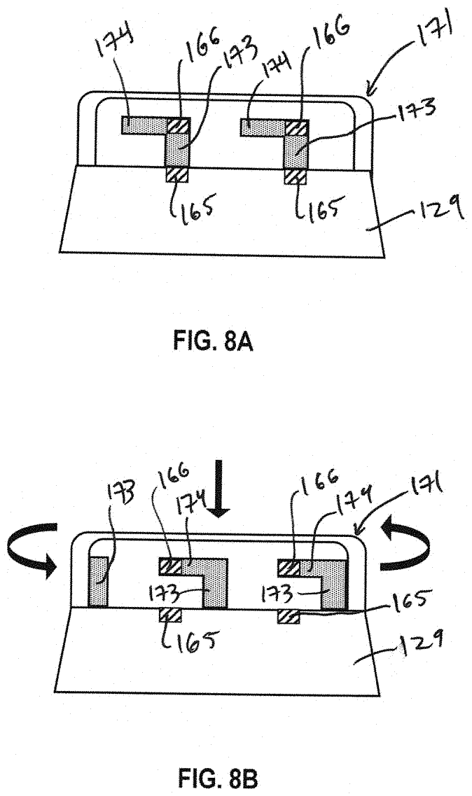

Referring to FIGS. 7-8, the face seal 104 can be manufactured using a soft and flexible polymer such as silicone or any other skin-safe material. Similar to the mask body 102, the face seal 104 is meant to be manufactured by publicly accessible methods and material. To achieve this, a two-part pour/press hybrid mold 200 was developed such that the mold 200 can be 3D printed without the need for support or excess material. In some embodiments, the mold 200 includes a top section 202 (FIG. 8A) and a bottom section 204 (FIG. 8B) which, when pressed together collectively define an interior cavity 206 which provides a mold 200 for the face seal 104. Once the mold 200 has been 3D printed, the mold 200 is immediately ready for use and requires no additional processing or finishing to be used in manufacturing the face seal 104. Depending on the intended area of use, a polymer may be determined for use based on its properties such as skin contact safety, resistance to various sterilization processes, and environment of use. These flexible polymers are typically acquired as two-part sets that are mixed in specified ratios and poured into the mold. It is recommended that the internal surfaces of the mold 200 are prepped with a mold release agent, commonly an aerosol application, to ensure ease of removal of the molded face seal 104. When the mold 200 is prepared, the polymer being used is mixed and prepared according to its specifications and poured into the bottom piece 204 of the mold 200. Once poured, the top piece 202 of the mold 200 is lowered onto the bottom piece 204 and pressed down. This pressing motion extracts any excess material and completes the internal cavity 206 of the mold 200 for the face seal 104. After the polymer's specified curing time has passed, the top piece 202 of the mold 200 is separated from the bottom piece 204, and the completed face seal 104 is removed from the mold 200. After separation, the face seal 104 may require minimal cleanup along any of the mold part lines. The face seal 104 is then placed around the peripheral edge 128 of the mask body 102, thereby fitting inside its engagement recess 145 matching the peripheral edge 128 of the mask body 102. Similar to the mask body 102, the face seal 104 can be quickly and easily removed, replaced, and/or individually sterilized.

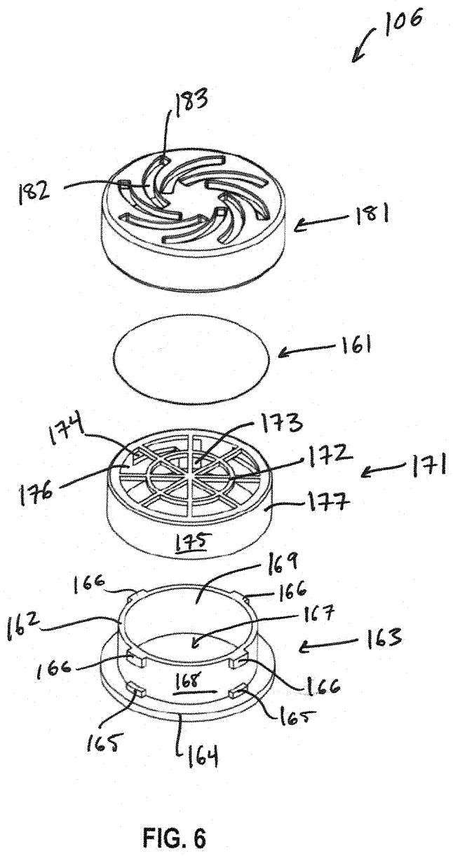

Referring to FIGS. 2 and 6, in some embodiments the filter assembly 106 includes a filter retainer 162 configured to encapsulate a filter material 161. The filter retainer 162 includes an adapter 163 for insertion within the filter engagement aperture 126 of the mask body 102, while the adapter 163 provides a base to secure the filter assembly 106 to the mask body 106. In some embodiments, the filter lock 171 is further included within the filter assembly 106 to receive the filter material 161 and, during assembly, may be twisted into engagement with the adapter 163. The filter assembly 106 further includes a filter cap 181 having a plurality of vent holes 183 to draw air in and hold the filter material 161 in place between the filter cap 181 and the filter lock 171.

In some embodiments, the adapter 163 defines a generally cylindrical body 162 forming an outer surface 168 and an opposite inner surface 169. The outer surface 168 defines an annular flange 164 and an aperture 167 extending axially through the adapter 163. As shown, a plurality of lower tabs 165 are defined on the outer surface 168 along the adapter 163 and above the annular flange 164 as shown in FIGS. 2 and 6. When coupled with the mask body 102, the annular flange 164 engages the concave inner surface 122 of the mask body 102 and prevents the adapter 163 from being pulled out of the filter engagement aperture 126. The notches 127 of the filter engagement aperture 126 engage with each respective lower tab 165 of the plurality of lower tabs 165 to prevent rotation of the adapter 163 within the filter engagement aperture 126. A plurality of upper tabs 166 are similarly defined along the outer surface 168 of the adapter 163 to provide engagement points for the filter lock 171. The outer surface 168 of the adapter 163 is configured to couple with the filter lock 171. In some embodiments, the adapter 163 is open at either end of the cylindrical body 162.

Referring to FIGS. 6-8B, in some embodiments the filter lock 171 includes a similarly shaped cylindrical body 177 defining an outer surface 175 and an inner surface 176. The inner surface 176 defines a plurality of twist lock slots 173 defined along for insertion of each of the plurality of upper tabs 166 of the adapter 163. The twist lock 171 includes a grate 172 at an upper end of the cylindrical body 177 for reception of a filter material 161 which allows air to pass through the filter material and into the mask assembly 100 when worn. During assembly, the twist lock 171 is situated directly above the adapter 163 such that each of the twist lock slots 173 are in direct alignment with one of the upper tabs 166. The twist lock 171 is then lowered onto the adapter 163 such that each of the upper tabs 166 reach a maxima within the respective twist lock slot 173. The twist lock 171 is then rotated clockwise or counterclockwise (in the embodiment of FIGS. 6 and 7, counterclockwise) such that each of the upper tabs 166 is seated within a respective twist lock seat 174. As shown in FIGS. 6 and 7, the filter lock 171 is configured to receive the filter material 161 such that the filter material 161 is seated on the grate 172.

Referring to FIGS. 2, 6-8B, the filter assembly 106 further includes a filter cap 181 configured for engagement with the filter lock 171. The filter cap 181 forms an inner cap surface 182 for encapsulating the filter material 161 within a filter cavity 185 defined by the filter cap 181 and the twist lock 171 of the filter assembly 106. The cap surface 182 includes a plurality of cap surface apertures 183 to allow air to pass through the filter cap 181, the filter material 161, and the twist lock 171 of the filter assembly 106. In some embodiments, the diameter of the filter cap 181 may be slightly larger than the diameter of the twist lock 171 such that the filter cap 181 can be coupled to the twist lock 171 in a press-lock engagement and become frictionally secured. In other embodiments, the filter cap 181 and twist lock 171 can be fitted with a helical screw thread lock mechanism (not shown) to allow a user to twist the filter cap 181 onto the twist lock 171.

In some embodiments, the filter material 161 can be any filter material the user has on hand, be it N95 material or any other suitable material. The filter material 161 can be cut to match the fit of the filter assembly 106 and inserted within the filter cavity 185 formed by the twist lock 171 and filter cap 181. The filter material 161 and filter assembly 106 can also be individually removed, replaced, and/or sterilized separately from the remainder of the mask assembly 100.

The mask assembly 100 can be manufactured in pieces with conventional fabrication techniques. For instance, the mask body 102, filter assembly 106, and the mold 200 can be fabricated using additive manufacturing (3D printers) or injection molding with 2-part tooling. This has been made possible by intentionally designing each of these parts to avoid 45 degree angles to aid in 3D printing. In addition, each of these parts are intentionally tapered to allow for ease of separation from the mold in case injection molding is used. The face seal 104 can be manufactured through injection molding using the mold 200.

Upon assembly, the adapter 163 of the filter assembly 106 is inserted into the filter engagement aperture 126 of the mask body 102 such that each of the lower tabs 165 of the adapter 163 becomes seated within the respective notch 127 of the filter engagement aperture 126. The twist lock 171 of the filter assembly 106 is then engaged with the adapter 163 by lowering the twist lock 171 onto the adapter 163 such that each of the upper tabs 166 of the adapter 163 enter the respective twist lock slot 173 of the twist lock 171. The twist lock 171 is then rotated clockwise or counterclockwise such that the upper tabs 166 become seated within the respective twist lock seat 174 of the twist lock 171. The filter material 161 is then cut to size and placed over the grate 172 of the twist lock 171. The filter cap 181 of the filter assembly 106 is then pressed over the twist lock 171 to secure the filter material 161 within the filter cavity 185. The face seal 104 is engaged with the mask body 102 by insertion of the peripheral edge 128 of the mask body 102 into the engagement recess 145 of the face seal. Elastic straps (not shown) are looped within each anchor point 125 of the mask body 102. When the wearer puts the mask on, the elastic straps can be looped around and secured at the back of the head using the strap retainer 130. When changing out the filter material 161, the filter cap 181 is removed to expose and replace the filter material 161. New filter material 161 may then be placed on the grate 172 of the twist lock 171.

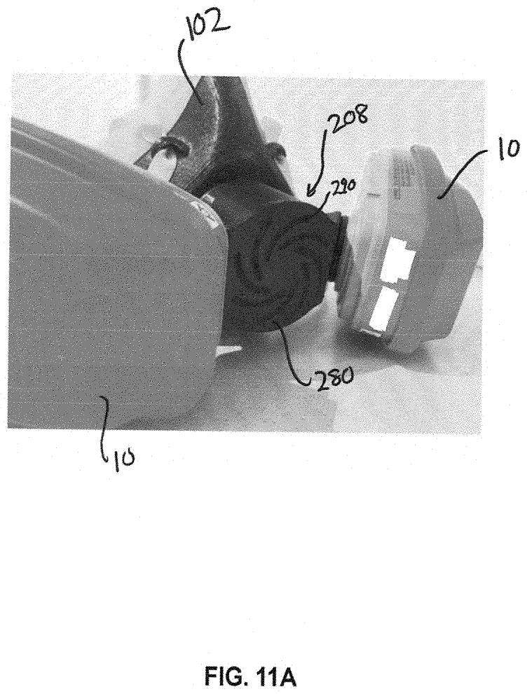

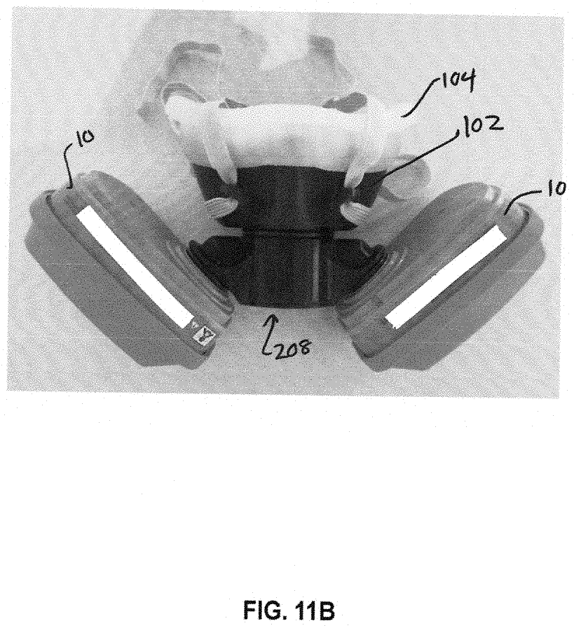

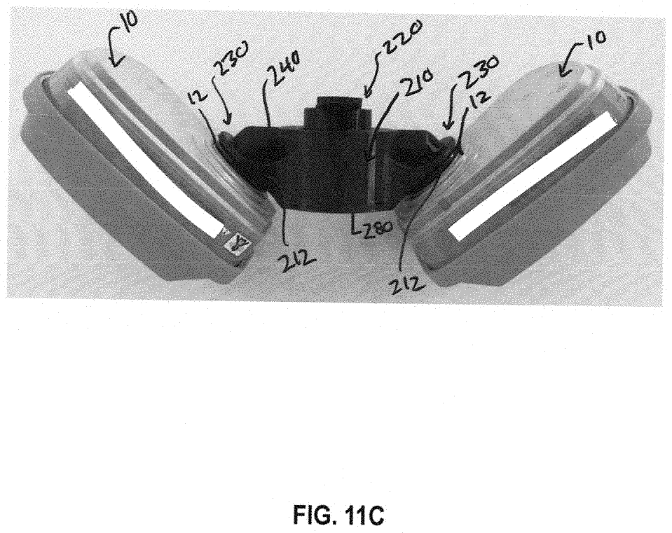

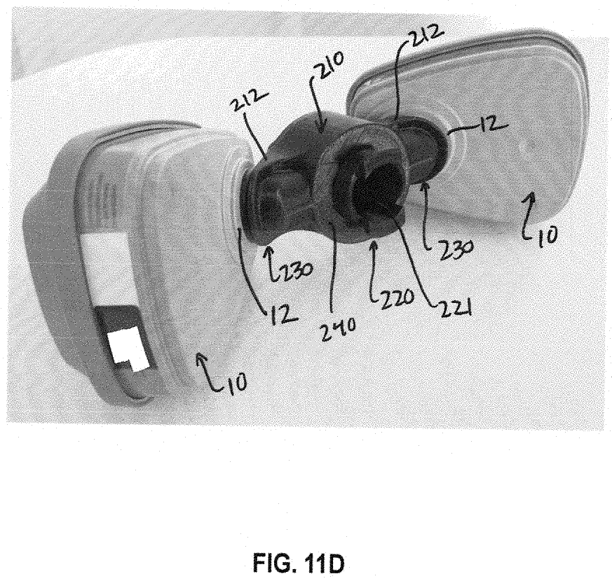

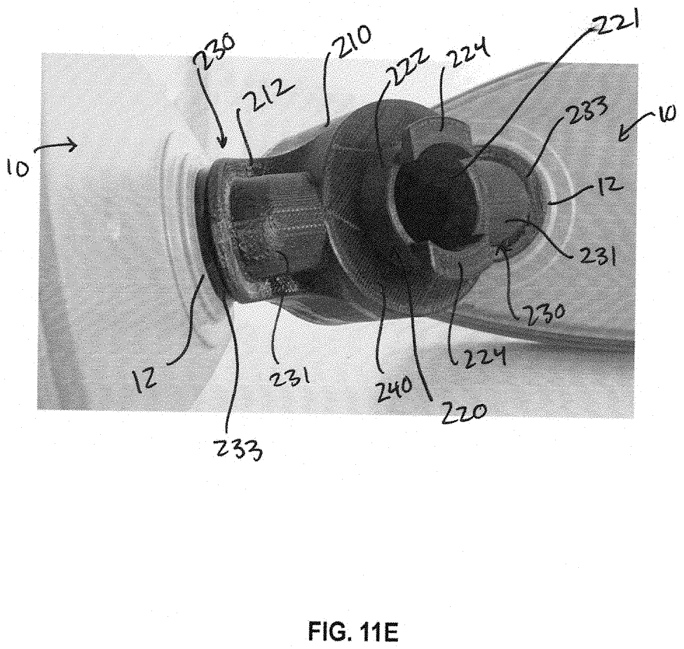

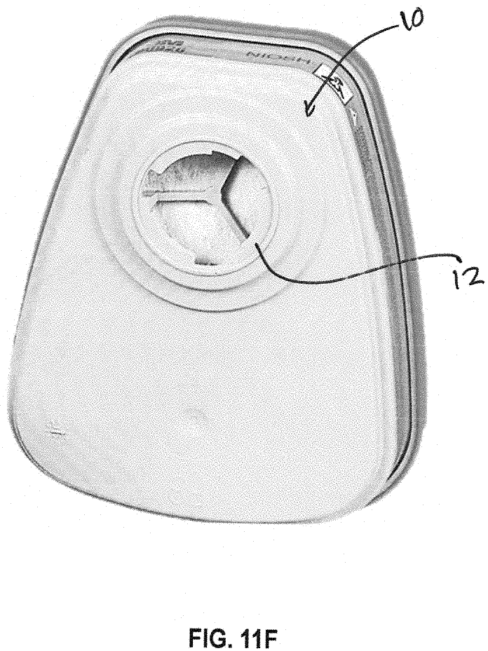

Referring to FIGS. 11A-11F, an alternate embodiment of the adapter 208 is illustrated for receipt of one or more filter cartridges 10. The adapter 208 engages with the filter engagement aperture 126 at the front 121 of the mask body 102 to enable a wearer to use filter cartridges 10. The adapter 208 defines a chamber body 210 in fluid flow communication with a pair of filter block stems 230 that allow passage of air between a respective filter cartridge 10 and the mask body 102. The chamber body 210 defines a front surface 280 and an opposite rear surface 240. The rear surface 240 is configured to couple with the front 121 of the mask body 102 and can include a primary stem 220 extending from the rear surface 240 for respective engagement with the filter engagement aperture 126. The primary stem 220 defines a primary stem body 222 that terminates in a primary aperture 221 in fluid flow communication with the chamber body 210. The primary stem 220 can include at least one partial flange 224 for a twist-lock engagement with the plurality of notches 127 of the filter engagement aperture 126. An appropriately shaped filter engagement aperture 126B for the primary stem 220 of FIGS. 11D and 11E is illustrated in FIG. 4E. In some embodiments, the front surface 280 can include a logo 290 or other similar features.

The adapter 208 includes a pair of filter block stems 230 that each engage a respective filter cartridge 10. Each filter block stem 230 defines a respective conduit 231 in fluid flow communication with the chamber body 210 that terminates in a cartridge flange 233, Cartridge flange 233 is configured for insertion within a respective cartridge aperture 12 of the filter cartridge 10, and the shape of the cartridge flange 233 depends on the design of the filter cartridge 10. In the embodiment of FIGS. 11A-11F, a suitable filter cartridge can be a 3M 60926 or another cartridge-based respirator filter. In some embodiments, for added structural integrity, each filter block stem 230 can include a respective support buttress 212 that extends from the front surface 280 of the chamber body 210 towards the associated cartridge flange 233. In some embodiments, the adapter 208 is manufactured by an additive process such as 3D printing or can be manufactured by other means such as injection molding.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A face mask assembly, comprising:
a mask body defining a convex outer surface, the convex outer surface defining a peripheral edge and a flat front with the flat front forming a filter engagement aperture;
a face seal defining a front and a rear, wherein the front of the face seal includes an engagement recess configured to receive the peripheral edge of the mask body and wherein the rear of the face seal includes an outer lip; and
a filter assembly configured to engage the mask body and a filter material, comprising:
an adapter, the adapter configured to couple with the filter engagement aperture;
a filter lock defining a grate and a twist-lock mechanism, wherein the twist-lock mechanism is configured to engage with the adapter and wherein the grate is configured and operable to receive a filter material therein; and
a filter cap defining an outer surface and a plurality of apertures and configured to engage the filter lock such that the filter material is encapsulated within a filter cavity collectively formed by the filter cap and the filter lock.

2. The face mask assembly of claim 1, further comprising:
a plurality of anchor points defined along the concave surface of the mask body, wherein each anchor point of the plurality of anchor points is configured to receive a respective strap.

3. The face mask assembly of claim 2, further comprising:
a strap retainer configured to receive and retain each respective strap behind a head of a wearer.

4. The face mask assembly of claim 1, wherein the adapter defines a generally cylindrical shape.

5. The face mask assembly of claim 4, wherein the adapter defines an annular flange and a plurality of lower tabs along a lower end of the adapter for engagement with the filter engagement aperture.

6. The face mask assembly of claim 5, wherein the filter engagement aperture defines a plurality of notches configured to receive each respective lower tab of the plurality of lower tabs of the adapter. The face mask assembly of claim 4, wherein the adapter defines a plurality of upper tabs defined at an upper end of the adapter for engagement with the filter lock.

8. The face mask assembly of claim 1, wherein the filter lock includes a plurality of twist-lock slots defined vertically along an interior surface of the filter lock to receive each respective upper tab of a plurality of upper tabs of the adapter.

9. The face mask assembly of claim 8, wherein the filter lock includes a plurality of twist-lock seats defined perpendicular to each respective twist-lock slot along an interior surface of the filter lock to receive each respective upper tab of a plurality of upper tabs of the adapter.

10. The face mask assembly of claim 9, wherein the filter lock is configured and operable to engage the adapter such that each upper tab of the adapter is inserted within the respective twist-lock slot of the filter lock and the filter lock is rotated clockwise or counterclockwise to secure each upper tab of the adapter within its respective twist-lock seat.

11. The face mask assembly of claim 1, wherein the engagement recess of the face seal follows an outline of the peripheral edge of the mask body.

12. The face mask assembly of claim 1, wherein the outer lip of the face seal is configured to contact a face of a wearer such that a seal is created between the mask body and the face of the wearer.

13. The face mask assembly of claim 1, wherein the filter cap is configured to be coupled with the filter lock in a press-fit engagement.

14. The face mask assembly of claim 1, wherein the face seal is comprised of a flexible material and is fabricated using injection molding.

15. The face mask assembly of claim 1, wherein the mask body is fabricated using additive manufacturing such that no support material is required.

16. The face mask assembly of claim 1, wherein the mask body is fabricated using injection molding.

17. The face mask assembly of claim 1, wherein the filter assembly is fabricated using an additive manufacturing process.

18. A method of manufacturing a face mask assembly, the method comprising:
inserting a peripheral edge of a mask body defining a filter engagement aperture into an engagement recess of a face seal, the engagement recess defining a shape that follows an outline of the peripheral edge of the mask body;
inserting an adapter defining a plurality of lower tabs at a lower end of the adapter into the filter engagement aperture of the mask body such that the plurality of lower tabs are engaged within each respective notch of a plurality of notches of the filter engagement aperture;
lowering a filter lock onto the adapter such that each twist lock slot of a plurality of twist lock slots of the filter lock engages with a respective upper tab of a plurality of upper tabs of the adapter;
rotating the filter lock clockwise or counterclockwise such that each upper tab of the adapter is seated within a respective twist lock seat of the adapter; and
engaging a filter cap with the filter lock.

19. The method of claim 18, further comprising:
placing a filter material on a grate of the filter lock such that the filter material is encapsulated by the filter lock and the filter cap.

20. The method of claim 19, further comprising:
engaging a first end of each of a plurality of straps with each respective anchor point of a plurality of anchor points defined along a convex surface of the mask body; and
engaging a second end of each of the plurality of straps with a strap retainer, wherein the strap retainer is situated behind a head of a wearer.

21. A filter assembly for a face mask, including:
a filter retainer collectively defined by:
an adapter defining a generally cylindrical body and at least one upper tab defined on the body of the adapter;
a filter lock defining a grate, at least one twist-lock slot defined vertically along an interior surface of the filter lock that terminates in a respective twist-lock seat defined perpendicular to the twist-lock slot, wherein the twist-lock slot and twist-lock seat receive each a respective upper tab of the one or more upper tabs of the adapter; and
a filter cap defining an outer surface and a plurality of apertures and configured to engage the filter lock, wherein the engagement of the filter cap and the filter lock collectively form a filter cavity; and
a filter material disposed within the filter cavity such that the filter material is encapsulated by the filter cap and the grate of the filter lock.

22. The filter assembly of claim 21, wherein the adapter is configured to secure within a filter engagement aperture of a mask body.

23. The filter assembly of claim 22, wherein the adapter defines an annular flange configured to engage a concave inner surface of the mask body and wherein the annular flange includes at least one lower tab configured to engage a respective notch of the filter engagement aperture of the mask body.

24. The filter assembly of claim 21, wherein the filter cap is configured to be coupled with the filter lock in a press-fit engagement.

25. A face mask assembly, comprising:
a mask body defining a convex outer surface, the convex outer surface defining a peripheral edge and a flat front with the flat front forming a filter engagement aperture;
a face seal defining a front and a rear, wherein the front of the face seal includes an engagement recess configured to receive the peripheral edge of the mask body and wherein the rear of the face seal includes an outer lip; and
a filter assembly engaged to the mask body, including:
an adapter, the adapter configured to couple within the filter engagement aperture and including a chamber body in fluid flow communication with at least one filter conduit, the chamber body defining a primary stem for engagement with the filter engagement aperture; and
at least one filter cartridge, the filter cartridge configured to engage a respective filter conduit of the adapter.

26. The face mask assembly of claim 25, wherein the primary stem adapter defines at least one partial flange for engagement with the filter engagement aperture.
